(19) United States
(12) Patent Application Publication
(10) Pub. No.: US 2010/0112424 A1
(43) Pub. Date: May 6, 2010

(54) BATTERY PACK STRUCTURE

(75) Inventor: Tsuyoshi Hayashi, Nishikamo-gun (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi, Aichi-ken (JP)

(21) Appl. No.: 12/523,247

(22) PCT Filed: Jan. 31, 2008
(86) PCT No.: PCT/JP2008/052003

§ 371 Date: Jul. 15, 2009

(30) Foreign Application Priority Data
Feb. 7, 2007 (JP) 2007-028072

(51) Int. Cl. H01M 2/10

(52) U.S. Cl. 429/99

(57) ABSTRACT

A battery pack structure includes a battery including a plurality of stacked battery cells, a battery casing accommodating the battery, and a restraint band generating a fastening force in a direction of stacking of the battery cells to hold integrally the plurality of battery cells. The restraint band is fixed to the battery casing. This structure provides the battery pack structure that fixes the battery to the casing body while suppressing increase in number of parts.

### TECHNICAL FIELD

The present invention generally relates to a battery pack structure, and particularly to a battery pack structure that is mounted on a vehicle as a drive power source and is formed of a lithium-ion battery.

### BACKGROUND ART

In connection with a conventional battery pack structure, for example, Japanese Patent Laying-Open No. 9-120808 has disclosed an alkaline storage battery of a stacked sealed type that aims to achieve a reduced weight and high productivity as well as a stable and enhanced fastening strength, to prevent deformation of each cell in use and to suppress lowering of performance (Patent Document 1). In the patent document 1, end plates are arranged on opposite ends of the stacked cells, respectively. The vertical walls of the end plates are fastened and fixed together by a plurality of binding bands each having a belt-like form. The binding band is made of a stainless steel plate.

Japanese Patent Laying-Open No. 2006-24445 has disclosed a battery assembly aiming at long life and increased safety (Patent Document 2). The battery assembly disclosed in the patent document 2 includes a plurality of battery boxes, restraint plates arranged on the opposite ends of the plurality of battery boxes, and a restraint rod restraining the plurality of battery boxes to prevent increase in distance between the restraint plates. The restraint plates are screwed to a lower casing accommodating the battery assembly.

Japanese Patent Laying-Open No. 2002-343324 has disclosed a battery restraint structure aiming to facilitate an operation for restraining the battery (Patent Document 3). In the patent document 3, a plurality of batteries are integrally restrained to form an onboard battery pack for a vehicle. The battery is, e.g., a nickel hydrogen battery.

In the battery pack structure disclosed in the above patent document 1, the binding bands that generate a fastening force in a stacking direction of the cells integrally hold the plurality of cells to form a module storage battery. When this module storage battery is accommodated in a casing body to form a battery pack, it is required to fix firmly the storage battery to the casing body. For this, it may be envisaged to couple the storage battery and the casing body together using independent parts such as brackets. However, this results in a problem that the parts of the battery pack increase in number.

### DISCLOSURE OF THE INVENTION

An object of the invention is to overcome the above problem, and particularly to provide a battery pack structure in which a battery is fixed to a casing body while suppressing increase in number of parts.

A battery pack structure includes a battery including a plurality of stacked battery cells; a casing body accommodating the battery; and a restraint member generating a fastening force in a direction of stacking of the battery cells to hold integrally the plurality of battery cells. The restraint member is fixed to the casing body.

In the battery pack structure thus configured, the restraint member integrally holding the plurality of battery cells is used as a member fixing the battery to the casing body. Thereby, the battery can be fixed to the casing body while suppressing increase in number of parts.

Preferably, the restraint member is made of metal. In the battery pack structure thus configured, the battery can be fixed to the casing body more firmly.

Preferably, the casing body and the restraint member are made of an electrically conductive material. The casing body is electrically grounded. In the battery pack structure thus configured, an electrolyte may leak from the battery to short-circuit the restraint member to the battery. Even in this case, an electric shock can be prevented because the restraint member is fixed to the electrically grounded casing body.

Preferably, the casing body includes a lower casing carrying the battery, and an upper casing combined with the lower casing to cover the battery. The restraint member is fixed to the lower casing. In the battery pack structure thus configured, the restraint member can be fixed to the lower casing with the battery laid on the lower casing in a battery assembling step. Therefore, it is possible to improve workability in the battery assembling process.

Preferably, the battery is formed of a lithium-ion battery. In the battery pack structure thus configured, the foregoing effect(s) described above can be achieved in the battery pack internally having the lithium-ion battery.

As described above, the invention can provide the battery pack structure that fixes the battery to the casing body while suppressing increase in number of parts.

### BRIEF DESCRIPTION OF THE DRAWINGS

FIG. 1 is an exploded view of an assembly of a battery pack employing a battery pack structure of an embodiment of the invention.

FIG. 2 is a cross section of the battery pack taken along line II-II in FIG. 1.

FIG. 3 is a cross section of the battery pack taken along line III-III in FIG. 1.

FIG. 4 is a cross section showing a modification of the battery pack structure in FIG. 1.

### BEST MODES FOR CARRYING OUT THE INVENTION

Embodiments of the invention will now be described with reference to the drawings. In the following description, the same or corresponding portions bear the same reference numbers.

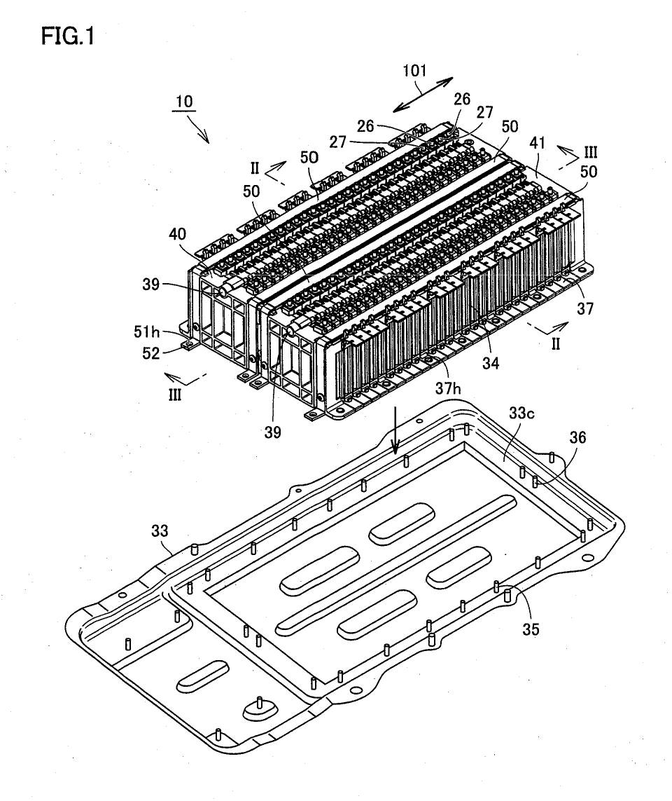

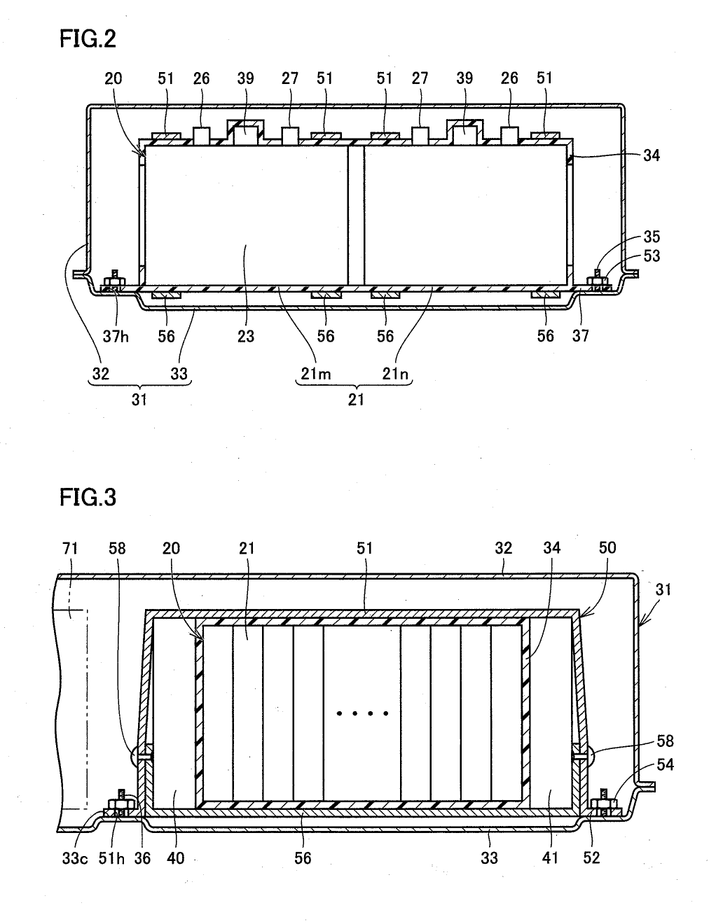

FIG. 1 is an exploded view of an assembly of a battery pack employing a battery pack structure of an embodiment of the invention. FIG. 2 is a cross section of the battery pack taken along line II-II in FIG. 1.

Referring to FIGS. 1 and 2, a battery pack 10 is mounted on a hybrid vehicle that employs, as drive power sources, an internal combustion engine such as a gasoline or Diesel engine and a chargeable battery (secondary battery). Battery pack 10 is mounted in an appropriate position on the vehicle and, for example, is mounted in a vehicle compartment such as a space under a seat or in a console box, or in a luggage room.

Battery pack 10 includes a battery 20, which is a lithium-ion battery. Battery 20 may be any chargeable secondary battery and, for example, may be a nickel hydrogen battery.

Battery 20 includes a plurality of battery cells 21, which are stacked in a direction that is indicated by an arrow 101 in FIG. 1 and will be referred to as a “stacking direction” of battery cells 21 hereinafter. In this embodiment, battery sets each formed of battery cells 21m and 21n that are arranged in parallel are stacked in the direction indicated by arrow 101. Battery 20 is a square-shaped battery. Battery 20 has a weight of 10 kg or more. Battery 20 has substantially a rectangular parallelepiped form. In a plan view, battery 20 has long and short sides. The direction of the long side matches the stacking direction of battery cells 21.

Battery cells 21 include positive and negative terminals 26 and 27. The plurality of battery cells 21 are stacked such that positive terminal 26 of each battery cell 21 is aligned to a negative terminal 27 of neighboring battery cell 21. Positive terminal 26 of each battery cell 21 is connected to negative terminal 27 of neighboring battery cell 21 by a bus bar. The plurality of battery cells 21 are electrically connected together in series.

Each battery cell 21 is pinched by a battery holder 34, which is made of a resin material such as polypropylene or polymer of polypropylene. Battery holder 34 forms a cooling air passage 23 between battery cells 21 neighboring together in the stacking direction. Battery 20 heated by the charging/discharging is cooled by cooling air passing through cooling air passage 23. Battery holder 34 forms a discharge gas passage 39 that externally discharges a gas generated in battery cell 21.

FIG. 3 is a cross section of the battery pack taken along line III-III in FIG. 1. Referring to FIGS. 1 to 3, end plates 40 and 41 are arranged on the opposite sides of the stacked battery cells 21, respectively. The plurality of battery cells 21 are held between end plates 40 and 41, which are made of a resin material such as polypropylene or polymer of polypropylene.

Battery pack 10 includes restraint bands 50 as restraint members. The plurality of restraint bands 50 are employed. Each restraint band 50 is made of metal. Restraint band 50 is made of an electrically conductive material. Restraint band 50 is made of, e.g., a steel plate. Restraint bands 50 have a strength larger than battery holder 34 and end plates 40 and 41. Restraint band 50 has a belt-like form. Restraint band 50 has a substantially rectangular section. Restraint band 50 may have another section, e.g., of a circular form or a polygonal form other than the rectangular form.

Restraint band 50 generates a fastening force in the stacking direction of battery cells 21. Restraint band 50 extends in the stacking direction of battery cells 21, and goes around battery 20. Restraint band 50 pushes end plates 40 and 41 to reduce a distance between them. According to this structure, restraint band 50 integrally holds the plurality of stacked battery cells 21 together.

Restraint band 50 includes an upper restraint band 51 as a first restraint band and a lower restraint band 56 as a second restraint band. Upper restraint band 51 extends from a top end of battery 20 to side surfaces thereof. Lower restraint band 56 extends from the bottom surface of battery 20 to side surfaces thereof. Upper and lower restraint bands 51 and 56 partially overlap together on the side surfaces of battery 20. Upper and lower restraint bands 51 and 56 are coupled together by pin members 58 on the side surfaces of battery 20.

Restraint band 50 may take another form and, for example, may be formed of only upper restraint band 51. In this case, upper restraint band 51 is coupled to end plates 40 and 41 so that the fastening force can be generated in the stacking direction of battery cells 21.

Battery pack 10 includes a battery casing 31. Battery 20 is accommodated in battery casing 31. Battery casing 31 forms an outer shell of battery pack 10. Battery casing 31 is made of metal. Battery casing 31 is made of an electrically conductive material. For ensuring a strength, battery casing 31 is made of, e.g., a galvanized steel plate. Battery casing 31 is fixed to a vehicle body. Battery casing 31 is electrically grounded.

Battery casing 31 includes upper and lower casings 32 and 33. Lower casing 33 includes a carrying surface 33c. Battery 20 is laid on carrying surface 33c. In other words, lower casing 33 bears a weight of battery 20. Carrying surface 33c is provided with stud bolts 35 and 36. Upper casing 32 is combined with lower casing 33 to cover battery 20. Lower casing 33 is arranged vertically under battery 20, and upper casing 32 is arranged vertically above battery 20.

Restraint band 50 is fixed to battery casing 31. More specifically, upper restraint band 51 is fixed to lower casing 33. Upper restraint band 51 includes flanges 52. Flange 52 is opposed to carrying surface 33c and is parallel to it. Flange 52 is formed by bending the end of upper restraint band 51 into an L-shaped form. Flange 52 is provided with a hole 51h. Stud bolt 36 is inserted into hole 51h. A nut 54 is engaged with stud bolt 36 to fix battery 20 to battery casing 31. The ends of upper restraint band 51 is fixed to battery casing 31.

In this embodiment, battery holder 34 is fixed to battery casing 31. More specifically, battery holder 34 is fixed to lower casing 33. Battery holder 34 includes flanges 37. Flange 37 is opposed to carrying surface 33c and is parallel to it. Flange 37 is provided with a hole 37h. Stud bolt 35 is fitted into hole 37h. A nut 53 is engaged with stud bolt 35 to fix battery 20 to battery casing 31.

Restraint bands 50 and battery holder 34 fix the four sides, in a plan view, of battery 20 to battery casing 31. Restraint band 50 fixes the short sides, in the plan view, of battery 20 to battery casing 31. Battery holder 34 fixes the long sides, in the plan view, of battery 20 to battery casing 31. Restraint band 50 fixes the opposite ends, in the stacking direction of battery cells 21, of battery 20 to battery casing 31. Battery holder 34 fixes the opposite ends, in the direction perpendicular to the stacking direction of battery cells 21, of battery 20 to battery casing 31.

Restraint band 50 is present as an electric conductor arranged near a high-pressure portion. In this case, an electrolyte may leak from battery 20 to restraint band 50 so that battery 20 may be short-circuited to restraint band 50. In the embodiment, however, restraint band 50 is fixed to electrically grounded battery casing 31. Also, battery casing 31 accommodates a battery monitor unit 71 together with battery 20. Battery monitor unit 71 has a function of detecting electric leak of battery casing 31. Accordingly, battery pack 10 of the embodiment can prevent an electric shock that may occur through restraint band 50, and further can detects the short circuit between battery 20 and restraint band 50 in an early stage.

A battery pack structure according to the embodiment of the invention includes battery 20 including the plurality of stacked battery cells 21, battery casing 31 serving as the casing body accommodating battery 20, and restraint bands 50 that generate the fastening force in the stacking direction of battery cells 21 and serves as the restraint member integrally holding the plurality of battery cells 21. Restraint band 50 is fixed to battery casing 31.

Battery 20 is mounted on the hybrid vehicle that is the vehicle. Battery 20 is mounted on the hybrid vehicle as a drive power source.

The above battery pack structure according to the embodiment of the invention uses restraint band 50 as the means for fixing battery 20 to battery casing 31 so that it is not necessary to employ an additional member such as a bracket, and increase in number of the parts can be avoided.

For accommodating battery 20 in battery casing 31, battery 20 must be fixed firmly to battery casing 31. Particularly, when battery 20 is a lithium-ion battery, it is necessary to satisfy requirements that are determined in predetermined vibration test and impact test according to the laws and regulations about transportation. Since battery 20 to be mounted on the vehicle as the drive power source has a large weight, it is difficult to satisfy the above requirements.

According to the embodiment, however, restraint band 50 made of metal is fixed to battery casing 31. Therefore, battery 20 can be fixed more firmly to battery casing 31, as compared with the case where only battery holder 34 made of a resin material is fixed to battery casing 31.

Then, a method of assembling battery pack 10 in FIG. 1 will be described. First, the plurality of battery cells 21 are stacked, and end plates 40 and 41 are arranged on the opposite sides thereof, respectively. A pressure is applied in the stacking direction to the plurality of stacked battery cells 21. Restraint bands 50 are arranged on battery 20 that is kept in the pressure-receiving state so that the plurality of battery cells 21 are integrated. The applied pressure is released to complete a stack assembly of battery 20. Battery 20 is laid on carrying surface 33c of lower casing 33. Restraint band 50 is fastened to lower casing 33 with nuts 53 and 54. Upper casing 32 is fixed to lower casing 33. Through the above steps, battery pack 10 in FIG. 1 is completed.

In battery pack 10 of the embodiment, since restraint band 50 is fixed to lower casing 33, the fastening operation can be performed with battery 20 laid on lower casing 33. Therefore, it is possible to improve workability in the process of fixing battery 20 to battery casing 31.

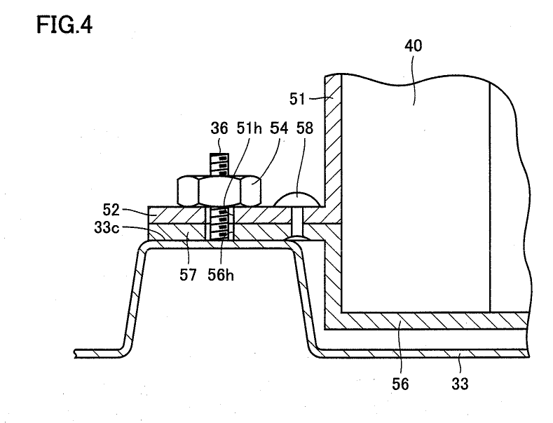

FIG. 4 is a cross section showing a modification of the battery pack structure in FIG. 1. FIG. 1 shows, on an enlarged scale, a portion where restraint band 50 is fixed to battery casing 31.

Referring to FIG. 4, lower restraint band 56 in this modification includes a flange 57. Flange 57 overlaps with flange 52. Flange 57 has a hole 56h communicating with hole 51h. A pin member 58 couples flanges 52 and 57 together. Stud bold 36 is fitted into holes 51h and 56h. By engaging nut 54 with stud bold 36, battery 20 is fixed to battery casing 31.

According to the above structure, the portions of flanges 52 and 57 overlapping together are fixed to battery casing 31 so that battery 20 can be fixed to battery casing 31 more firmly.

Although this embodiment employs the structure that uses both restraint band 50 and battery holder 34 for fixing battery 20 to battery casing 31, a structure that uses only restraint band 50 may be employed. The form in which battery cells 21 are stacked is not restricted to that shown in FIG. 1, and battery 20 may be formed of battery cells 21 stacked, e.g., in one row.

The invention may be applied to a Fuel Cell Hybrid Vehicle (FCHB) using a fuel cell and a battery as drive power sources as well as an Electric Vehicle (EV). In the hybrid vehicle of the embodiment, the internal combustion engine operates in an operation point of optimum fuel consumption. In the fuel cell hybrid vehicle, the fuel cell operates in an operation point of optimum power generation efficiency. Both the types of hybrid vehicles use the batteries basically in the same manner.

Although the present invention has been described and illustrated in detail, it is clearly understood that the same is by way of illustration and example only and is not to be taken by way of limitation, the scope of the present invention being interpreted by the terms of the appended claims.

### INDUSTRIAL APPLICABILITY

The invention is used in the hybrid vehicle that uses the internal combustion engine and the battery as drive power sources, the fuel cell hybrid vehicle using the fuel cell and the battery as the drive power sources, and the electric vehicle.

1. A battery pack structure comprising:
a battery including a plurality of stacked battery cells;
a casing body accommodating said battery; and
a restraint member generating a fastening force in a direction of stacking of said battery cells to hold integrally said plurality of battery cells, wherein said restraint member extends in the direction of stacking of said battery cells and goes around said battery, and
said restraint member is fixed to said casing body.

2. The battery pack structure according to claim 1, wherein
said restraint member is made of metal.

3. The battery pack structure according to claim 1, wherein
said casing body and said restraint member are made of an electrically conductive material, and
said casing body is electrically grounded.

4. The battery pack structure according to claim 1, wherein
said casing body includes a lower casing carrying said battery, and an upper casing combined with said lower casing to cover said battery, and
said restraint member is fixed to said lower casing.

5. The battery pack structure according to claim 1, wherein
said battery is formed of a lithium-ion battery.
